(19) United States
(12) Patent Application Publication
(10) Pub. No.: US 2026/0148953 A1
(43) Pub. Date: May 28, 2026

(54) REFILLABLE LAMP FOR LASER SUSTAINED PLASMA LIGHT SOURCE

(71) Applicant: KLA Corporation, Milpitas, CA (US)

(72) Inventor: Ilya Bezel, Mountain View, CA (US)

(21) Appl. No.: 19/364,094

(22) Filed: Oct. 21, 2025

Related U.S. Application Data
(60) Provisional application No. 63/724,406, filed on Nov. 24, 2024.

(51) Int. Cl. H01J 61/30; H01J 61/02; H01J 61/36

(52) U.S. Cl. CPC H01J 61/30; H01J 61/361; H01J 61/025

(57) ABSTRACT

A refillable plasma lamp assembly for laser-sustained plasma light sources is disclosed. The lamp assembly includes a transparent lamp body defining a sealed internal volume, a glass-to-metal fitting with a metal flange, and a glass-to-metal seal hermetically coupling the lamp body and fitting. The lamp flange is configured to connect to an external gas fitting for supplying and removing working gas to and from the sealed internal volume during plasma operation. The lamp body may be connected to a glass portion of the glass-to-metal fitting via a glass-to-glass connection. The lamp assembly may include a fill port for gas exchange between the lamp flange and the external gas fitting. This construction enables dynamic control of gas composition and pressure in semiconductor metrology and inspection applications. The refillable design improves safety by permitting unpressurized shipping and resists deterioration from reactive gases.

### CROSS-REFERENCE TO RELATED APPLICATION

The present application claims priority to U.S. Provisional Application Ser. No. 63/724,406, filed Nov. 24, 2024, which is incorporated herein by reference in their entirety.

### TECHNICAL FIELD

The present disclosure generally relates to laser-sustained plasma (LSP) light sources, and, more particularly, to refillable lamp constructions that allow dynamic control of gas composition and pressure during operation.

### BACKGROUND

Laser-sustained plasma (LSP) light sources are widely used in broadband inspection and metrology tools for semiconductor manufacturing. Generally, near-infrared continuous-wave pump laser light is focused into a high-pressure gas medium—such as xenon, argon, krypton, or mixtures thereof—contained within an optically transparent vessel. This vessel may be configured as a glass bulb, a cell with transparent walls, or a chamber with discrete input and output windows. The various plasma vessels operate at pressures reaching many tens to over one hundred atmospheres, and maintaining this high-pressure gas within the vessel is necessary for reliable LSP operation. The broadband emission from plasma is collected through the vessel's transparent components and directed into inspection or imaging optics as an illumination source for semiconductor metrology and inspection applications.

Commonly, sealed fused silica or glass lamps are employed for LSP light generation in the 170-1200 nm spectral range. In such implementations, the lamp is filled and sealed during manufacture by freezing the working gas at cryogenic temperatures, sealing the fill port, and then warming to generate positive internal pressure. Once sealed, the internal pressure is dictated by lamp temperature and cannot be adjusted in situ. As a result, this approach precludes the use of low-boiling gases, such as neon or helium, which cannot be efficiently frozen during filling. Furthermore, fixed-composition lamps cannot accommodate dynamic tuning of gas mixture or pressure during operation. High-pressure glass vessels also pose safety risks during shipping and handling, and seals may deteriorate under reactive gas mixtures and plasma-induced heating. Moreover, reliable plasma ignition can be compromised if the cold-fill pressure falls outside an optimal range. As a result, providing a lamp construction for laser-sustained plasma light sources that allows for in-service adjustment of gas composition and pressure while improving safety and operational flexibility would be desirable.

Typically, the gas filling process for high-pressure lamps includes: (i) attaching a glass fill-port tube to the lamp and connecting a volume of gas to the fill port; (ii) cooling the lamp down to liquid nitrogen temperatures to freeze the gas into the lamp volume, which creates negative internal pressure in the lamp—lower than atmospheric pressure; (iii) sealing the fill port tube while the gas is frozen inside of the lamp, with the necessary condition being internal pressure lower than external atmospheric pressure; and (iv) raising the temperature of the lamp for the gas to evaporate and create high positive pressure inside the lamp. Typical pressures are tens of atmospheres for LSP lamps. The sealed pressurized lamp is installed in the LSP lamphouse, ignited, and operated, during which the internal pressure of the lamp can increase even further, reaching over a hundred atmospheres.

The current production process does not allow for freezing gases with low boiling temperatures—Ne, He, H₂—during the gas filling step. For example, Ne freezes at 24.6K and boils at 27.1K, which is far below liquid N2 freezing at 63.2K. As a result, Ne cannot be collected in sufficient quantities inside the lamp. If the lamp has high internal pressure, sealing becomes unfeasible. Consequently, high-pressure Ne- or He-containing sealed lamps cannot be produced using standard methods. In addition, once sealed, the pressure in the lamp is determined by the average temperature of the gas inside the lamp. The higher the temperature, the higher the pressure. Optimal LSP operating pressure decreases with pump power, but the gas temperature increases. As a result, a sealed lamp can only be adjusted for specific pump power and temperature conditions. Further, the process does not allow for changing gas composition freely during lamp operation and there is a significant safety hazard associated with shipping and handling high-pressure glass lamps. For example, when dropped or struck, lamps explode violently, producing multiple sharp glass projectiles. Sealed lamps may have pressure that is either too low or too high for reliable ignition and the seals are prone to deterioration due to chemical reactions that may occur in LSP containing reactive species. This is particularly concerning when handling used lamps that may be weakened by exposure to UV light.

As a result, providing a lamp construction for laser-sustained plasma light sources that overcomes the limitations of prior approaches is desirable.

### SUMMARY

A refillable plasma lamp assembly is disclosed. In some aspects, the refillable plasma lamp assembly includes a transparent lamp body defining a sealed internal volume. In some aspects, the lamp assembly includes a glass-to-metal fitting including a lamp flange. In some aspects, a glass-to-metal seal hermetically couples the transparent lamp body and the glass-to-metal fitting to provide a fluid connection between the lamp body and the lamp flange. In some aspects, the lamp flange is configured to couple to an external gas fitting configured to supply and remove a working gas to and from the sealed internal volume.

A laser-sustained broadband light source is disclosed. In some aspects, the laser-sustained broadband light source includes a refillable lamp assembly configured to define a sealed internal volume. In some aspects, the refillable lamp assembly includes a transparent lamp body defining a sealed internal volume and a glass-to-metal fitting comprising a lamp flange. In some aspects, a glass-to-metal seal hermetically couples the transparent lamp body and the glass-to-metal fitting to provide a fluid connection between the lamp body and the lamp flange. In some aspects, the lamp flange is configured to couple to an external gas fitting configured to supply and remove a working gas to and from the sealed internal volume. In some aspects, the broadband light source further comprises a gas-handling system configured to supply and remove a working gas to and from the sealed internal volume via the lamp flange. In some aspects, the broadband light source further comprises a pump laser source configured to direct a pump beam into the sealed internal volume to sustain a plasma in the working gas. In some aspects, the broadband light source further comprises a light collection element configured to collect broadband light from the plasma. In some aspects, the laser-sustained broadband light source may be incorporated into an optical characterization system, such as, but not limited to, an inspection system or a metrology system.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures.

FIGS. 1A-1B illustrate a refillable plasma lamp assembly, in accordance with one or more embodiments of the present disclosure.

FIG. 2 illustrates the refillable plasma lamp equipped with an O-ring, in accordance with one or more embodiments of the present disclosure.

FIG. 3 the refillable plasma lamp equipped with a reinforcing end cap and bonder, in accordance with one or more embodiments of the present disclosure.

FIGS. 4A-4C illustrate the installation process of the refillable plasma lamp assembly, in accordance with one or more embodiments of the present disclosure.

FIG. 5 shows an LSP broadband light source incorporating the refillable plasma lamp assembly, in accordance with one or more embodiments of the present disclosure.

FIG. 6 illustrates a simplified schematic view of an optical characterization system incorporating the refillable plasma lamp assembly, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to a refillable lamp construction for LSP light sources. Unlike conventional sealed lamps, the lamp design of the present disclosure incorporates a glass-to-metal seal and an external gas fitting, enabling the lamp to be filled, refilled, or adjusted during operation. This configuration allows for dynamic control of the gas composition and pressure, facilitating the use of low-boiling-point gases such as neon and helium, which were previously impractical. The refillable design also enables the lamp to operate at pressures optimized for varying pump power and thermal conditions, significantly enhancing the performance and adaptability of LSP systems. Additionally, the refillable lamp may be shipped unpressurized, eliminating the safety hazards associated with high-pressure sealed lamps during transportation and installation. The glass-to-metal seal is engineered to withstand high operating pressures (e.g., 50 -250 bar) and resist deterioration in the presence of reactive gases, ensuring long-term reliability.

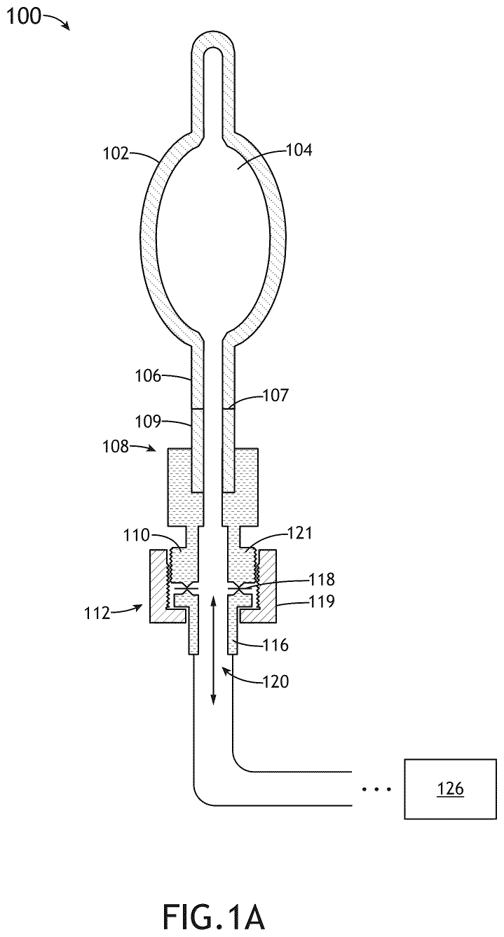

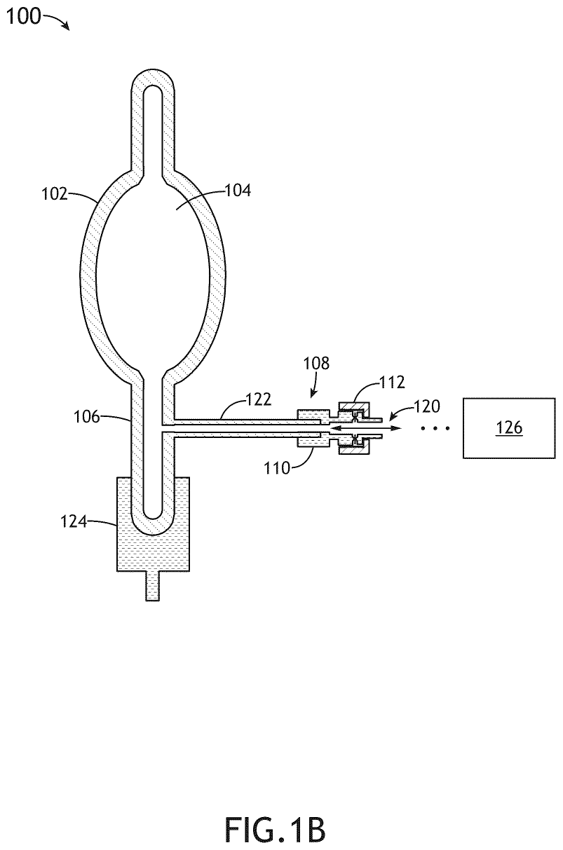

FIGS. 1A-1B illustrate a refillable plasma lamp assembly 100, in accordance with one or more embodiments of the present disclosure. In embodiments, the refillable plasma lamp assembly 100 includes a transparent lamp body 102 that defines a sealed internal volume 104 for containing a working gas for production of a plasma. In embodiments, the transparent lamp body 102 includes a stem 106 and a glass-to-metal fitting 108. In embodiments, a glass-to-metal seal hermetically couples the transparent lamp body 102 to the glass-to-metal fitting 108 to provide a connection between the transparent lamp body 102 and the lamp flange 110. In embodiments, the glass-to-metal fitting 108 includes a lamp flange 110 (e.g., metal flange). The lamp flange 110 provides a robust, leak-tight interface for high-pressure operation and serves as a mechanical lamp mounting interface for installation within a lamphouse. In embodiments, the stem 106 of the transparent lamp body 102 is connected to the glass portion 109 of the glass-to-metal fitting 108 via a glass connection 107.

In embodiments, the lamp flange 110 of the glass-to-metal fitting 108 is configured to couple to an external gas fitting 112. The external gas fitting 112 may include an external flange 116 (e.g., metal flange) and, upon connection with the lamp flange 110, supplies and/or removes working gas 120 to and from the sealed internal volume 104 during plasma operation. For example, the external gas fitting 112 may connect to a gas handling system 126. This configuration enables dynamic adjustment of the gas composition and pressure within the refillable plasma lamp assembly 100. In embodiments, a gasket 118 (e.g., metal gasket) is disposed between the lamp flange 110 and the external flange 116 to ensure a secure, high-pressure seal.

In embodiments, the lamp flange 110 of the glass-to-metal fitting 108 is threaded for connection with a threaded portion of the external gas fitting 112. For example, the external gas fitting 112 may include, but is not limited to the external flange 116 (e.g., metal flange) and a nut 119 with a corresponding thread to a threaded portion of the lamp flange 110. The nut 119 may be configured to press the lamp flange 110 of the glass-to-metal fitting 108 into the external flange 116 of the external gas fitting 112 and a gasket 118 disposed between the lamp flange 110 of the glass-to-metal fitting 108 and the external flange 116 of the external gas fitting 112 seals the connection upon compression by the nut 119. In embodiments, the external gas fitting 112 includes a VCR fitting and the glass-to-metal fitting 108 is constructed to be compatible with the VCR fitting.

In embodiments, as shown in FIG. 1B, refillable plasma lamp assembly 100 may include a fill port 122. For example, the glass-to-metal fitting 108 may include a fill port 122, which is fluidically coupled to the transparent lamp body 102. In this regard, gas 120 is exchanged through the fill port 122 by way of the connection between the lamp flange 110 and the external gas fitting 112. In additional and/or alternative embodiments, refillable plasma lamp assembly 100 may include a dedicated lamp mount 124 for mounting in a lamphouse.

The transparent lamp body 102 may be constructed from any optically transparent material known in the art of plasma production that permits transmission of pump laser radiation and broadband plasma emission. For example, the transparent lamp body 102 may be formed from, but is not limited to, fused silica, glass, or sapphire.

The refillable plasma lamp assembly 100 may accommodate any gas or gas mixture known in the art of broadband LSP light production. For example, the gas contained within the gas volume 104 of the refillable plasma lamp assembly 100 may include, but is not limited to, xenon, argon, krypton, neon, helium, H₂, or O₂, or mixtures thereof. The refillable design of the refillable plasma lamp assembly 100 enables the use of low-boiling-point gases, such as neon and helium, which are impractical in conventional sealed lamps due to the limitations of cryogenic filling and sealing methods. In embodiments, the refillable plasma lamp assembly 100 may also be filled with hydrogen or oxygen, either as pure gases or as components of a mixed gas environment. The ability to dynamically adjust the gas composition and pressure during operation allows for fine-tuning of plasma properties, ignition conditions, and emission spectra. This flexibility is particularly advantageous for applications requiring specific spectral ranges or plasma characteristics.

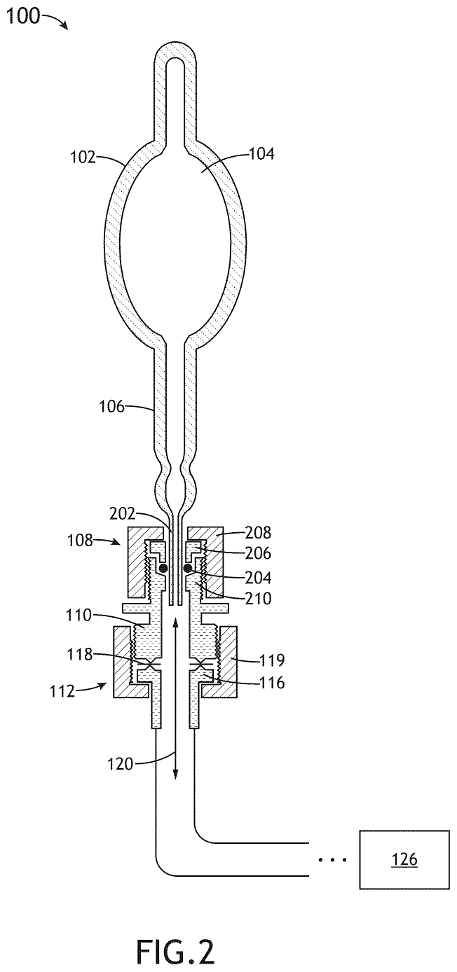

FIG. 2 illustrates the refillable plasma lamp assembly 100 equipped with an O-ring seal, in accordance with one or more embodiments of the present disclosure. In embodiments, the refillable plasma lamp assembly 100 includes a capillary 202, which extends from the transparent lamp body 102 and serves as a conduit for the working gas 120 to enter or exit the sealed internal volume 104. In embodiments, the refillable plasma lamp assembly 100 includes one or more O-rings 204. The one or more O-rings 204 may surround the capillary 202 to provide an elastic, high-pressure seal between the capillary 202 and the surrounding structure, preventing leakage of the working gas 120 during operation. In embodiments, a plunger 206 is positioned above the O-rings 204 and is configured to deform the O-rings 204, during engagement, such that they are compressed sufficiently to maintain the integrity of the seal around the capillary 202. This arrangement allows for reliable sealing while accommodating minor dimensional variations in the capillary 202. In embodiments, the refillable plasma lamp assembly 100 includes a nut 208 which secures the plunger 206 and O-rings 204. The nut 208 is threaded onto a corresponding fitting 210 of the glass-to-meal fitting 108 and, when tightened, the nut 208 applies force to the plunger 206, which in turn compresses the O-rings 204 around the capillary 202. This configuration ensures that the capillary 202 remains securely sealed and that the refillable plasma lamp assembly 100 can withstand the high operating pressures required for laser-sustained plasma generation. In additional and/or alternative embodiments, two O-rings may be implemented in a stacked configuration in order to improve centering the capillary 202 and avoid the capillary 202 from contacting the metal portions of the glass-to-metal fitting 108.

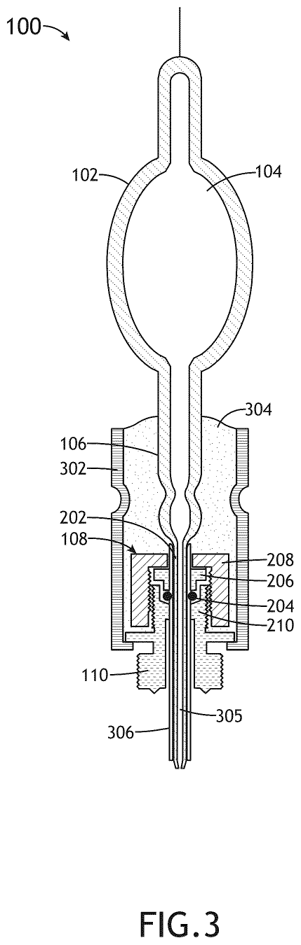

FIG. 3 illustrates the refillable plasma lamp assembly 100 equipped with an end cap, in accordance with one or more embodiments of the present disclosure. In embodiments, the refillable plasma lamp assembly 100 further includes an end cap 302. The end cap 302 may be positioned to surround the capillary 202 and the top portion of the glass-to-metal fitting 108. In embodiments, the end cap 302 may be coupled to the glass-to-metal fitting 108. For instance, the end cap 302 may be spot welded to the glass-to-metal fitting 108. In embodiments, the end cap 302 contains a bonder 304. The bonder 304 may include any material that will harden around the capillary 202 and the glass-to-metal fitting 108. For example, the bonder 304 may include, but is not limited to, cement, epoxy, or glue. The bonder 304 acts to mechanically reinforce the capillary 202. In addition, the end cap 302 and the stem 106 of the transparent lamp body 102 may include one or more locks to provide further reinforcement of the bonder 304 and lock the bonder 304 into place so the bonder 304 and transparent lamp body 102 do not slide relative to the end cap 302. Further, the bonder 304 shields the O-rings 204 from radiation generated by the plasma, while also reducing the rate of diffusion of outgassing compounds from the O-rings into the transparent lamp body 102. In embodiments, the capillary 202 includes an extended section. The extended section of the capillary 202 may be coated with a gold layer 306. The gold layer 306 serves to protect the O-rings 204 and other sealing components from radiation from the plasma as well chemical degradation, thereby extending the operational lifetime of the refillable plasma lamp assembly 100. Outgassing to the inside of the transparent lamp body 102 may also be managed by the periodic refill of the working gas 120.

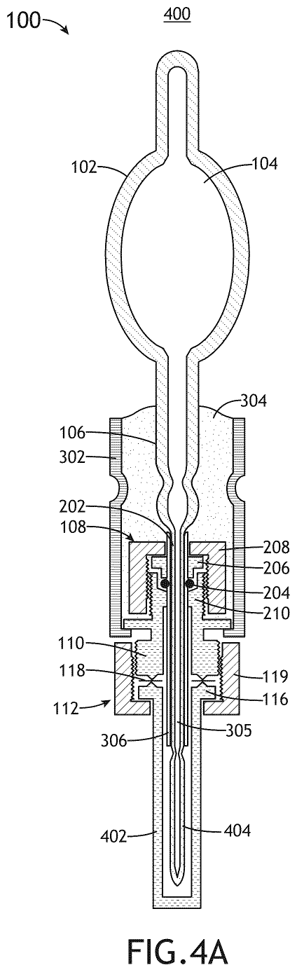

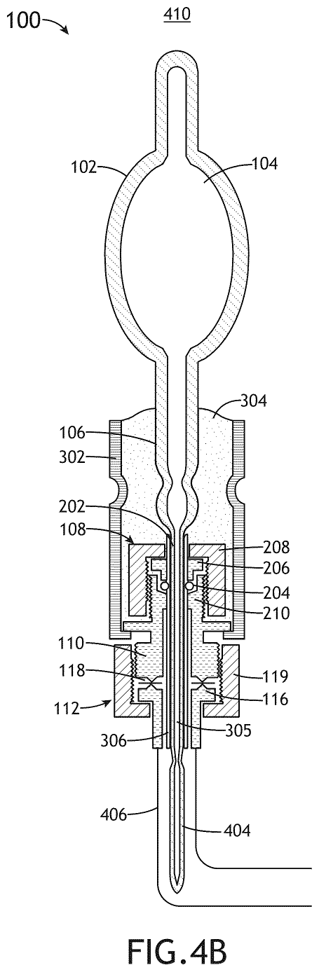

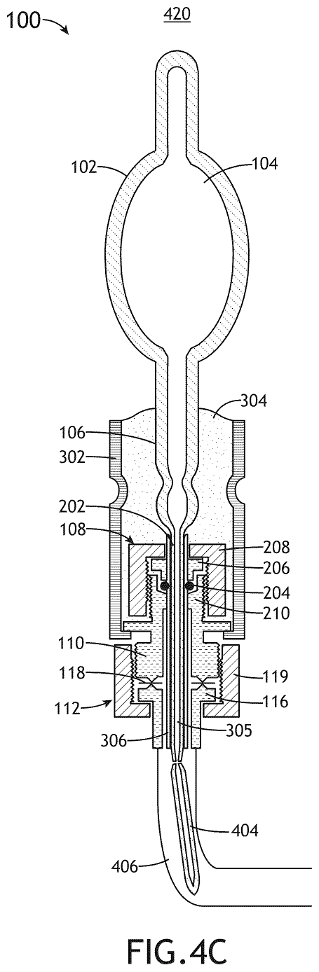

FIGS. 4A-4C illustrate the installation process of the refillable plasma lamp assembly 100, in accordance with one or more embodiments of the present disclosure. In a receiving step 400, as shown in FIG. 4A, the refillable plasma lamp assembly 100 is received with a shipping cap 402. The shipping cap 402 is secured about an end cap 404 of the refillable plasma lamp assembly 100 to protect the end cap 404 and transparent lamp body 102 during shipping and handling. The shipping cap 402 may be secured to the glass-to-metal fitting 108 using the nut 119 of the external gas fitting 112. In an installation step 410, as shown in FIG. 4B, the end cap 404 is inserted into an external gas supply line 406. At the same step, the external flange 116 may be secured to the lamp flange 110 via nut 119. In a breaking step 420, the end cap 404 may be broken in order to establish a fluid connection between the transparent lamp body 102 and the external gas supply line 406. In this implementation, the transparent lamp body 102 may be sealed prior to shipping and the capillary 305 may be broken immediately before installation or after the connection to the gas-handling system via the external gas supply line 406.

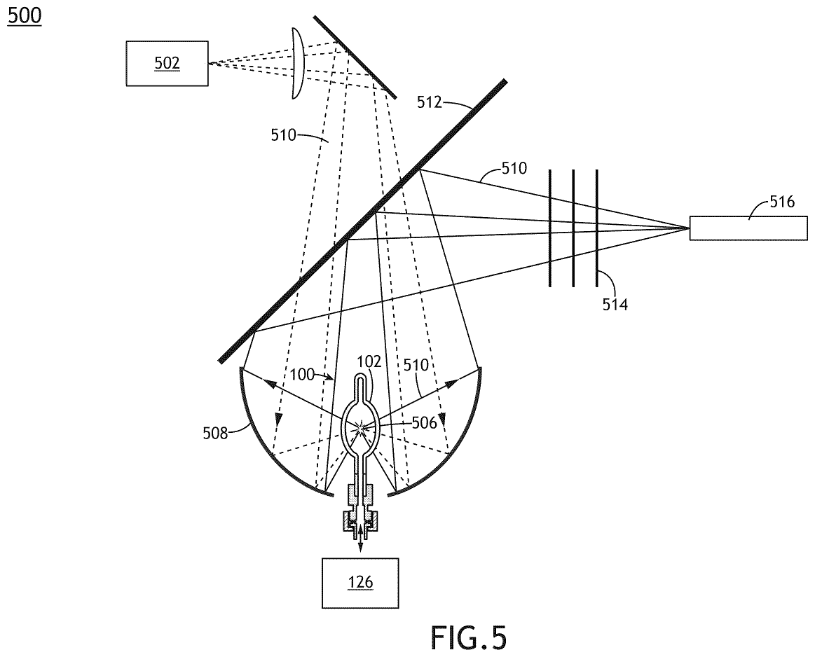

FIG. 5 illustrates an LSP broadband light source 500 incorporating the refillable plasma lamp assembly 100, in accordance with one or more embodiments of the present disclosure. It is noted that the various implementations and components described previously herein with respect to FIGS. 1-4 should be interpreted to extend to FIG. 5 unless otherwise noted. In embodiments, the LSP broadband light source 500 includes a laser pump source 502 for generating a pump beam 504.

The laser pump source 502 is configured to generate one or more pump beams 504, which acts as an optical pump, for sustaining plasma 506 within the interval volume 104 of the lamb body 102 of the refillable plasma lamp assembly 100. For example, the pump source 502 may emit one or more beams of laser illumination suitable for pumping plasma 506. In embodiments, the LSP broadband light source 500 includes a light collector element 508. The light collector element 508 is configured to direct a portion of the pump beam 504 to the contained in the transparent lamp body 102 to ignite and/or sustain plasma 506. The light collector element 508 may include any one or more light collector elements known in the art of LSP broadband light generation. For example, the light collector element may include one or more mirrors or one or more lenses. In embodiments, the light collector element may include a reflector assembly (e.g., elliptical or spherical reflective section). For example, as shown in FIG. 5, the light collector element 508 may include an elliptical reflector assembly. In additional and/or alternative embodiments, the light collector element 508 may include one or more discrete flat or curved mirrors and/or lenses. In additional and/or alternative embodiments, the light collector element 508 may include one or more retroreflecting mirrors for redirecting unabsorbed laser light back into plasma 506 for improved efficiency.

The pump beam may include radiation of any wavelength or wavelength range known in the art including, but not limited to, visible, IR radiation, NIR radiation, and/or UV radiation. The light collector element 508 is configured to collect a portion of broadband light 510 emitted from plasma 506. The broadband light 510 emitted from plasma 506 may be collected via one or more additional optics (e.g., a cold mirror 512) for use in one or more downstream applications (e.g., inspection, metrology, or lithography). The LSP broadband light source 500 may include any number of additional optical elements such as, but not limited to, one or more filter 514 or a homogenizer 516 for conditioning the broadband light 510 prior to the one or more downstream applications. The light collector element 508 may collect one or more of infrared, visible, NUV, UV, DUV, and/or VUV light emitted by plasma 506 and direct the broadband light 510 to one or more downstream optical elements. For example, the light collector element 508 may deliver infrared, visible, NUV, UV, DUV, and/or VUV light to downstream optical elements of any optical characterization system known in the art, such as, but not limited to, an inspection tool, a metrology tool, or a lithography tool. In this regard, the broadband light 510 may be coupled to the illumination optics of an inspection tool, metrology tool, or lithography tool. The pump source 502 may include any pump source known in the art suitable for igniting and/or sustaining plasma. For example, the pump source 502 may include one or more lasers (e.g., pump lasers). In embodiments, the laser pump source 502 may include one or more continuous wave (CW) pump lasers and/or one or more pulsed lasers. For example, the laser pump source 502 may include, but is not limited to, a fiber laser, a thin-disk laser, a frequency-doubled laser, or a diode laser. The pump source may include a pump source for sustaining plasma and an ignition source for igniting plasma. For example, the primary pump source may include one or more CW pump lasers, and the ignition source may include one or more pulsed lasers. Alternatively, the source 500 may include one or more electrodes for igniting plasma.

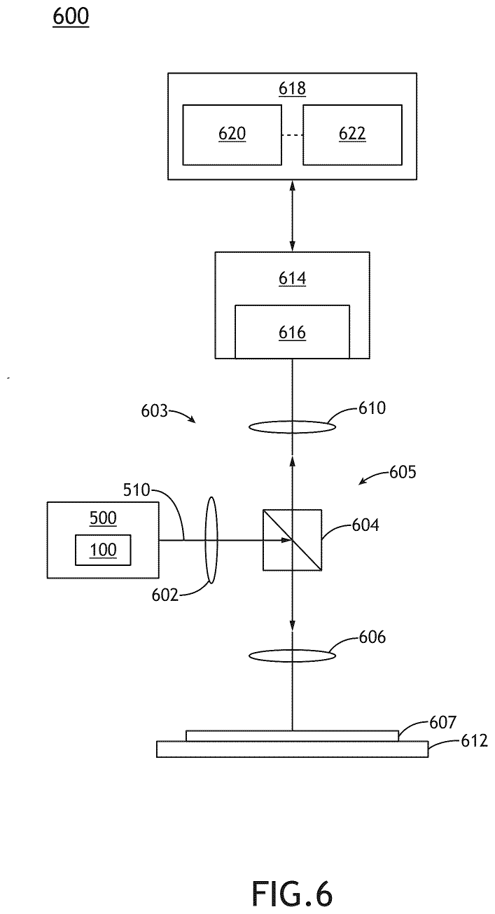

FIG. 6 illustrates a simplified schematic view of an optical characterization system 600 incorporating the LSP broadband light source, in accordance with one or more alternative and/or additional embodiments.

In embodiments, system 600 includes the LSP broadband light source 500 equipped with the refillable plasma lamp assembly 100, an illumination arm 603, a collection arm 605, a detector assembly 614, and a controller 618. It is noted herein that system 600 may comprise any imaging, inspection, metrology, lithography, or other characterization system known in the art. In this regard, system 600 may be configured to perform inspection, optical metrology, lithography, and/or any form of imaging on a sample 607. Sample 607 may include any sample known in the art including, but not limited to, a wafer, a reticle, a photomask, a flat panel display, and the like. It is noted that system 600 may incorporate one or more of the various embodiments of the LSP broadband light source 500 and refillable plasma lamp assembly 100 described throughout the present disclosure.

In embodiments, sample 607 is disposed on a stage assembly 612 to facilitate movement of sample 607. Stage assembly 612 may include any stage assembly 612 known in the art including, but not limited to, an X-Y stage, an R-θ stage, and the like. In embodiments, stage assembly 612 adjusts the position of sample 607 during inspection or imaging to maintain focus on sample 607.

In embodiments, the illumination arm 603 includes one or more illumination optics configured to direct broadband light 510 from the LSP broadband light source 500 to the sample 607. The illumination arm 603 may include any number and type of optical components known in the art. In embodiments, the illumination arm 603 includes one or more optical elements 602, a beam splitter 604, and an objective lens 606. In this regard, illumination arm 603 may be configured to focus broadband light 510 from the LSP broadband light source 500 onto the surface of the sample 607. The one or more optical elements 602 may include any optical element or combination of optical elements known in the art including, but not limited to, one or more mirrors, one or more lenses, one or more polarizers, one or more gratings, one or more filters, one or more beam splitters, and the like.

In embodiments, system 600 includes a collection arm 605 including one or more collection optics configured to collect light emanating (e.g., reflected, scattered, diffracted, and/or emitted) from sample 607. In embodiments, collection arm 605 may direct and/or focus the light from the sample 607 to a sensor 616 of a detector assembly 614. It is noted that sensor 616 and detector assembly 614 may include any sensor and detector assembly known in the art. The sensor 616 may include, but is not limited to, a CCD sensor or a CCD-TDI sensor. Further, sensor 616 may include, but is not limited to, a line sensor or an electron-bombardment line sensor.

In embodiments, detector assembly 614 is communicatively coupled to a controller 618 including one or more processors 620 and memory 622. For example, the one or more processors 620 may be communicatively coupled to memory 622, wherein the one or more processors 620 are configured to execute a set of program instructions stored on memory 622. In embodiments, the one or more processors 620 are configured to analyze the output of detector assembly 614 to analyze one or more characteristics of sample 607. In embodiment, the set of program instructions are configured to cause the one or more processors 620 to modify one or more characteristics of system 600 (e.g., focus control).

It is noted that the system 600 may be configured in any optical configuration known in the art including, but not limited to, a dark-field configuration, a bright-field orientation, and the like. The system 600 may be configured as any type of metrology tool or inspection tool known in the art.

Additional details of various embodiments of optical characterization system 600 are described in U.S. Pat. No. 7,957,066B2, entitled “Split Field Inspection System Using Small Catadioptric Objectives,” issued on Jun. 7, 2011; U.S. Published Patent Application 2007/0002465, entitled “Beam Delivery System for Laser Dark-Field Illumination in a Catadioptric Optical System,” published on Jan. 4, 2007; U.S. Pat. No. 5,999,310, entitled “Ultra-broadband UV Microscope Imaging System with Wide Range Zoom Capability,” issued on Dec. 7, 1999; U.S. Pat. No. 7,525,649 entitled “Surface Inspection System Using Laser Line Illumination with Two Dimensional Imaging,” issued on Apr. 28, 2009; U.S. Published Patent Application 2013/0114085, entitled “Dynamically Adjustable Semiconductor Metrology System,” by Wang et al. and published on May 9, 2013; U.S. Pat. No. 5,608,526, entitled “Focused Beam Spectroscopic Ellipsometry Method and System, by Piwonka-Corle et al., issued on Mar. 4, 1997; and U.S. Pat. No. 6,297,880, entitled “Apparatus for Analyzing Multi-Layer Thin Film Stacks on Semiconductors,” by Rosencwaig et al., issued on Oct. 2, 2001, which are each incorporated herein by reference in their entirety.

The one or more processors 720 of the present disclosure may include any one or more processing elements known in the art. In this sense, the one or more processors 720 may include any microprocessor-type device configured to execute software algorithms and/or instructions. In embodiments, the one or more processors 720 may be embodied in a desktop computer, mainframe computer system, workstation, image computer, parallel processor, networked computer, or other computer system configured to execute a program configured to operate the system 600 and/or LSP broadband light source 500, as described throughout the present disclosure. The term “processor” may be broadly defined to encompass any device having one or more processing elements, which execute program instructions from a non-transitory memory medium 722. Moreover, different subsystems of the various systems disclosed may include processor or logic elements suitable for carrying out at least a portion of the steps described throughout the present disclosure. The memory medium 722 may include any storage medium known in the art suitable for storing program instructions executable by the associated one or more processors 720. For example, the memory medium 722 may include a non-transitory memory medium. For instance, the memory medium 722 may include, but is not limited to, a read-only memory, a random-access memory, a magnetic or optical memory device, a solid-state drive, and the like.

One skilled in the art will recognize that the herein described components, operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A refillable plasma lamp assembly comprising:
a transparent lamp body defining a sealed internal volume; and
a glass-to-metal fitting comprising a lamp flange, wherein a glass-to-metal seal hermetically couples the transparent lamp body and the glass-to-metal fitting to provide a fluid connection between the transparent lamp body and the lamp flange,
wherein the lamp flange is configured to couple to an external gas fitting configured to supply and remove a working gas to and from the sealed internal volume.

2. The refillable plasma lamp assembly of claim 1, wherein the transparent lamp body is coupled to a glass portion of the glass-to-metal fitting via a glass connection.

3. The refillable plasma lamp assembly of claim 1, wherein the lamp flange is configured as a lamp mounting interface for mounting in a lamphouse.

4. The refillable plasma lamp assembly of claim 1, further comprising: a dedicated lamp mount interface configured to mount the refillable plasma lamp assembly within a lamphouse.

5. The refillable plasma lamp assembly of claim 1, further comprising:
a fill port, wherein the glass-to-metal fitting is coupled to the fill port via the glass-to-metal seal, wherein gas is exchanged through the fill port via a connection between the lamp flange of the glass-to-metal fitting and the external gas fitting.

6. The refillable plasma lamp assembly of claim 1, wherein the lamp flange of the glass-to-metal fitting is threaded for connection with a thread of the external gas fitting.

7. The refillable plasma lamp assembly of claim 6, wherein the external gas fitting comprises a VCR fitting.

8. The refillable plasma lamp assembly of claim 6, wherein the external gas fitting comprises: an external flange; and a nut.

9. The refillable plasma lamp assembly of claim 8, wherein the lamp flange of the glass-to-metal fitting and the nut of the external gas fitting are threaded, the nut being configured to press the lamp flange of the glass-to-metal fitting against the external flange of the external gas fitting, and a metal gasket being disposed between the lamp flange and the external flange.

10. The refillable plasma lamp assembly of claim 1, further comprising a capillary extending from the transparent lamp body.

11. The refillable plasma lamp assembly of claim 10, wherein the glass-to-metal fitting comprises one or more O-rings for coupling the glass-to-metal fitting to the capillary extending from the transparent lamp body.

12. The refillable plasma lamp assembly of claim 11, wherein the glass-to-metal fitting comprises a nut and a plunger configured to deform the one or more O-rings.

13. The refillable plasma lamp assembly of claim 11, wherein the capillary is coated with a layer of metal.

14. The refillable plasma lamp assembly of claim 11, further comprising: an end cap surrounding the capillary; and a portion of the glass-to-metal fitting.

15. The refillable plasma lamp assembly of claim 14, wherein the end cap contains a bonder, the bonder reinforcing the capillary and shielding the one or more O-rings from broadband light generated by a plasma, wherein the bonder comprises at least one of cement, epoxy, or glue.

16. The refillable plasma lamp assembly of claim 15, wherein the end cap comprises one or more locks configured to secure the bonder and prevent movement of the bonder relative to the end cap.

17. The refillable plasma lamp assembly of claim 10, further comprising: a shipping cap configured to protect the capillary and an end cap of the capillary during shipping and handling.

18. The refillable plasma lamp assembly of claim 1, wherein the working gas within the sealed internal volume comprises at least one of neon, helium, hydrogen, oxygen, xenon, krypton, or argon.

19. A laser-sustained broadband light source comprising:
a refillable lamp assembly configured to define a sealed internal volume, wherein the refillable lamp assembly comprises:
a transparent lamp body defining a sealed internal volume; and
a glass-to-metal fitting comprising a lamp flange, wherein a glass-to-metal seal hermetically couples the transparent lamp body and the glass-to-metal fitting to provide a fluid connection between the transparent lamp body and the lamp flange,
wherein the lamp flange is configured to couple to an external gas fitting configured to supply and remove a working gas to and from the sealed internal volume;
a gas-handling system configured to supply and remove a working gas to and from the sealed internal volume via the lamp flange;
a pump laser source configured to direct a pump beam into the sealed internal volume to sustain a plasma in the working gas; and
a light collector element configured to collect broadband light from the plasma.

20. The laser-sustained broadband light source of claim 19, wherein the light collector element comprises at least one of a mirror or lens.

21. The laser-sustained broadband light source of claim 19, wherein the light collector element comprises a reflector assembly.

22. The laser-sustained broadband light source of claim 21, wherein the light collector element comprises at least one of an elliptical reflector assembly or a spherical reflector assembly.

23. The laser-sustained broadband light source of claim 19, wherein the pump laser source comprises one or more continuous wave (CW) lasers or one or more pulsed lasers.

24. A characterization system comprising:
a laser-sustained light source comprising:
a refillable lamp assembly configured to define a sealed internal volume, wherein the refillable lamp assembly comprises:
a transparent lamp body defining a sealed internal volume; and
a glass-to-metal fitting comprising a lamp flange, wherein a glass-to-metal seal hermetically couples the transparent lamp body and the glass-to-metal fitting to provide a fluid connection between the lamp body and the lamp flange,
wherein the lamp flange is configured to couple to an external gas fitting configured to supply and remove a working gas to and from the sealed internal volume;
a gas-handling system configured to supply and remove a working gas to and from the sealed internal volume via the lamp flange during plasma operation;
a pump laser source configured to direct a pump beam into the sealed internal volume to ignite and sustain a plasma in the working gas; and a light collection assembly configured to collect broadband optical emission from a plasma; and
a light collector element configured to collect broadband light from the plasma,
wherein the characterization system further comprises:
a set of illumination optics configured to direct broadband light from the laser-sustained light source to one or more samples;
a set of collection optics configured to collect light emanating from the one or more samples; and
a detector assembly.

25. A method comprising:
providing a refillable lamp assembly defining a sealed internal volume, the refillable lamp assembly comprising:
a transparent lamp body;
a glass-to-metal seal hermetically coupled to the transparent lamp body; and
a glass-to-metal fitting coupled to the glass-to-metal seal and configured to interface with an external gas fitting;
coupling an external gas fitting to the glass-to-metal fitting;
supplying a working gas to the sealed internal volume via the external gas fitting and the glass-to-metal fitting;
directing a pump beam from a pump laser source into the sealed internal volume to sustain a plasma in the working gas; and
collecting broadband light from the plasma.
